(19) United States
(12) Patent Application Publication
(10) Pub. No.: US 2014/0364838 A1
(43) Pub. Date: Dec. 11, 2014

(54) NASAL RETENTION SYSTEM INCLUDING A FOAM CLIP

(71) Applicants: Kyle S. Adams, Dallas, TX (US); Gordon E. Atkinson, Black Mountain, NC (US)

(72) Inventors: Kyle S. Adams, Dallas, TX (US); Gordon E. Atkinson, Black Mountain, NC (US)

(73) Assignee: iMed Technology, Inc., Dallas, TX (US)

(21) Appl. No.: 14/459,355

(22) Filed: Aug. 14, 2014

Related U.S. Application Data
(63) Continuation-in-part of application No. 13/533,089, filed on Jun. 26, 2012.

(51) Int. Cl. A61J 15/00

(52) U.S. Cl. CPC A61J 15/0034; A61J 15/0003
USPC 604/516; 604/179

(57) ABSTRACT

A nasal retention system for securing a nasal tube extending through a nose of a patient. The retention system includes a clip member includes an elongated body formed of a resilient material, and defines a thickness between first and second planar sides. An adhesive coating is provided on the first planar side, and a detachable film cover is applied over the adhesive coating. The elongated body is bendable about a minor axis parallel to a minor dimension of the elongated body to adhere a first portion of the first planar side to a second portion of the first planar side.

### CROSS-REFERENCE TO RELATED APPLICATION

This application is A CONTINUATION-IN-PART APPLICATION of and claims priority to U.S. patent application Ser. No. 13/533,089, filed on Jun. 26, 2012, entitled “NASAL RETENTION SYSTEM INCLUDING A SPLIT BALL CLIP,” the entire disclosure of which is incorporated by reference herein.

### FIELD OF THE INVENTION

The present invention relates to nasal tube retention systems and, more particularly, to a clip member for retaining a nasal tube in a desired location within a patient.

### BACKGROUND OF THE INVENTION

A tubing inserted through the nasal passage of a medical patient may be provided to introduce fluids into the gastrointestinal tract of the patient. A securing system is required to support and maintain placement of the tubing once it is inserted through the nasal passage and appropriately positioned to achieve the desired treatment. Treatments administered to the patient by the nasal tube method can require that the tubing remain in place for extended periods of time. Hence, it is particularly important to provide a means of securing nasal tubing in a particular position for extended periods while providing maximum comfort for the patient.

Typically, the nasal tube securing system may use tape or may include a cord that passes around the patient's posterior nasal septum. The ends of the cord extend from the nostrils of the patient and may be secured to the nasal tube by an anchoring clip member. The anchoring clip member is positioned just below the nose of the patient and may become a source of irritation to the patient due to contact and/or movement between the clip member and the portion of patient's face adjacent to the clip member.

### SUMMARY OF THE INVENTION

In accordance with an aspect of the invention, a nasal retention system is provided for securing at least one nasal tube extending through a nose of a patient. The nasal retention system is provided in combination with a nasal tube extending into a nostril of the nose, a support cord extending around a nasal septum of the patient and having opposing ends, each cord end extending from a nostril of the nose, and a clip member engaged with the tube and engaged with the ends of the support cord. The clip member includes an elongated body formed of a resilient material, and having oppositely facing first and second planar sides defining a minor width dimension of the elongated body and a major length dimension of the elongated body that is perpendicular to the minor width dimension. The elongated body defines a thickness between the first and second planar sides, and includes an adhesive coating on the first planar side, and a detachable film cover applied over the adhesive coating. The elongated body is bendable about a minor axis parallel to the minor dimension to adhere a first portion of the first planar side to a second portion of the first planar side.

The film cover can be formed by first and second elongated film cover portions, wherein: a) the first film cover portion can extend over the first portion of the first planar side from a first end of the elongated body to a center of the elongated body where an end of the first film cover portion is positioned over the adhesive coating; and b) the second film cover portion can extend over the second portion of the first planar side from a second end of the elongated body to the center of the elongated body.

The first and second ends can be defined as curved edges.

The center of the elongated body can be defined by a minor axis extending perpendicular to the major dimension and located midway between the first and second ends of the elongated body.

The resilient material can be a closed cell foam material.

The elongated body can define a nasal tube clamping configuration when the elongated body is bent about the minor axis, and exterior surfaces of the clamping configuration can be entirely defined by surfaces of the closed cell foam material.

The closed cell foam material can be compressible in the direction of the thickness of the elongated body. The closed cell foam material can have a thickness of at least 1.0 mm.

In accordance with another aspect of the invention, a method is provided for securing a nasal tube extending through a nose of a patient, the method including providing a retention system comprising a clip member having an elongated body formed of a closed cell foam material having oppositely facing first and second planar sides defining a minor width dimension of the elongated body and a major length dimension of the elongated body that is perpendicular to the minor width dimension; the elongated body defining a thickness between the first and second planar sides; an adhesive coating on the first planar side; a detachable film cover applied over the adhesive coating on the first planar side. The method further includes: passing a first end of a support cord having first and second ends into one nostril past the posterior nasal septum, and retrieving the first end through the other nostril such that the first and second ends of the support cord extend from the patient's nostrils exterior to the nose; removing the film cover to expose the adhesive coating; positioning the clip member adjacent to the nose with the nasal tube located extending perpendicular to the major dimension; and bending the elongated body about a minor axis parallel to the minor dimension to adhere a first portion of the first planar side to a second portion of the first planar side and secure the nasal tube and the first and second ends of the support cord in fixed relation between the first and second portions of the first planar side.

The film cover can be formed by first and second elongated film cover portions, wherein: a) the first film cover portion can extend over the first portion of the first planar side from a first end of the elongated body to a center of the elongated body where an end of the first film cover portion is positioned over the adhesive coating; and b) the second film cover portion can extend over the second portion of the first planar side from a second end of the elongated body to the center of the elongated body.

The step of removing the film cover can be performed by the sequence of steps of: i) removing the first film cover portion from the first portion of the first planar side; ii) placing the nasal tube and the first and second ends of the support cord on the first portion of the first planar side; and iii) removing the second film cover portion from the second portion of the first planar side prior to bending the elongated body about the minor axis to adhere the first and second portions of the first planar side to each other.

Adhering the first and second portions of the first planar side to each other can include placing the first and second ends of the elongated body adjacent to each other, and a tail end of the clip can be formed comprising a portion of the elongated body extending from the first and second ends to a location on one of the nasal tube and the first and second ends of the support cord. A portion of the tail end may be trimmed.

The elongated body can define a nasal tube clamping configuration when the elongated body is bent about the minor axis, and exterior surfaces of the clamping configuration can be entirely defined by surfaces of the closed cell foam material.

The closed cell foam material can be compressible in the direction of the thickness of the elongated body.

The closed cell foam material can have a thickness of at least 1.0 mm.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 illustrates the components of a nasal retention system in accordance with aspects of the present invention;

FIG. 2 illustrates an insertion member and a retrieval member for the retention system of FIG. 1;

FIG. 3A is perspective view of an inner side of a clip member for the retention system;

FIG. 3B is a perspective view of an outer side of the clip member for the retention system;

FIG. 4 is an end elevation view of the clip member for the retention system;

FIG. 5 is a perspective view similar to that of FIG. 3A and including a protective film cover;

FIG. 6 is a perspective view illustrating the clip member closed over a nasal tube and retention cord ends;

FIGS. 7A-7C illustrate a process of using the nasal retention system of the present invention;

FIG. 8A is perspective view of an inner side of an alternative configuration for the clip member;

FIG. 8B is a perspective view of an outer side of the alternative configuration for the clip member;

FIG. 8C is a perspective view similar to that of FIG. 8A and including a protective film cover;

FIG. 8D is a cross-sectional perspective view taken along line 8D-8D in FIG. 8C;

FIG. 9A is a perspective view of a further configuration for a clip member;

FIG. 9B is a perspective view of the clip member of FIG. 9A with a first film cover portion removed, and with the clip member positioned in associated with a nasal tube and support cord;

FIG. 9C is a perspective view of the clip member of FIG. 9A with a second film cover portion removed; and

FIG. 9D is a perspective view of the clip member of FIG. 9A in a nasal tube clamping configuration.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

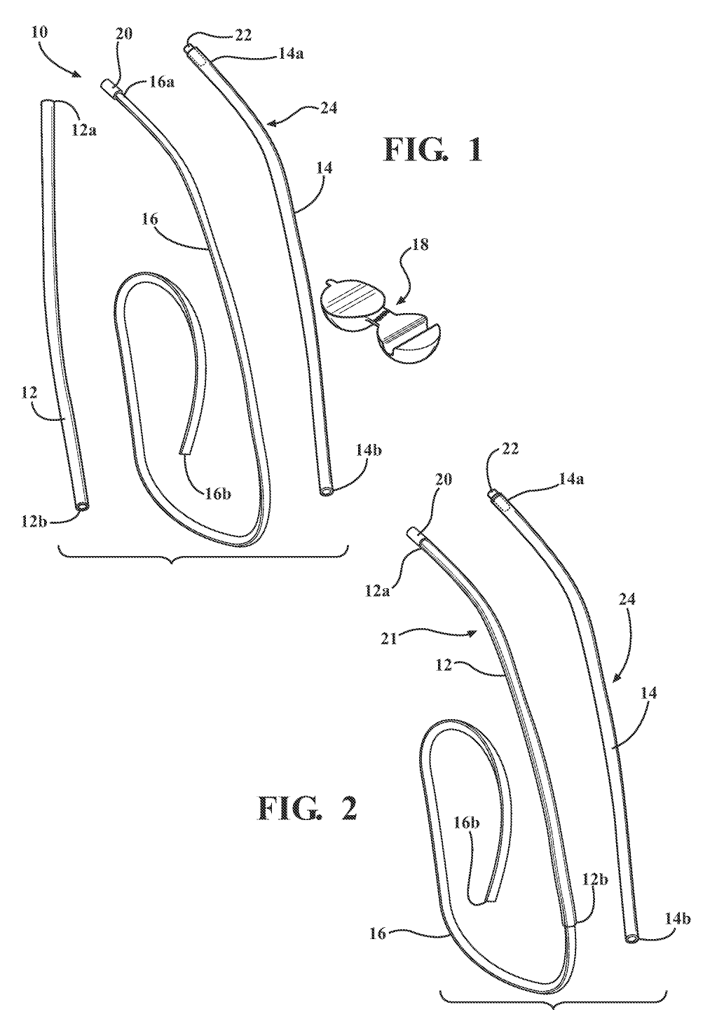

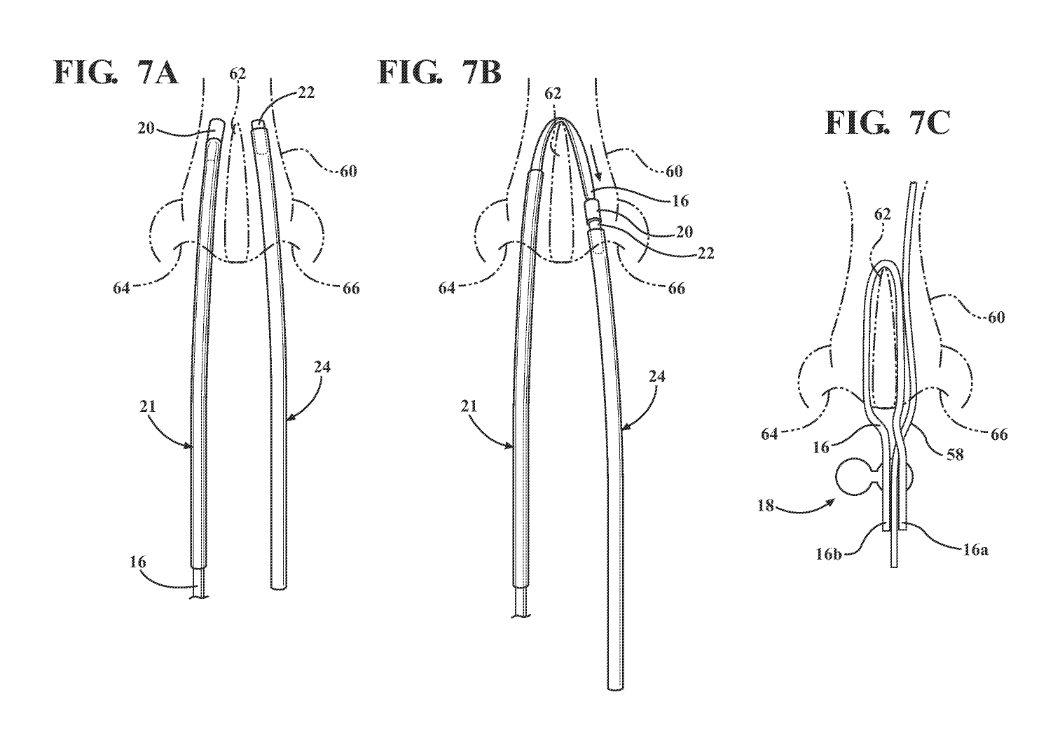

Referring to FIG. 1, in accordance an aspect of the invention, a collection of components or kit is described herein for providing a system 10 for placing and securing a nasal tube, e.g., a nasogastric tube, at a desired position relative to a patient's nose 60 (see FIG. 7A). The system 10 generally includes a first flexible tube or insertion tube 12, a second flexible tube or retrieval tube 14, a support chord 16 having a first cord end 16a and a second cord end 16b, and a clip member 18. The cord 16 preferably comprises an umbilical tape. The cord 16 and the clip member 18 define a nasal retention system wherein the cord 16 is provided for extending around the posterior nasal septum 62 (FIG. 7A) in a patient, to thereby support the nasal tube 58 (see FIG. 7C). The clip member 18 is provided to engage both the cord ends 16a, 16b and the nasal tube 58 to provide support for the nasal tube 58, as will be described further below.

Referring to FIGS. 1 and 2, the first end 16a of the cord 16 is attached to a first magnetic member 20 preferably comprising a stainless steel magnetic tip. The attachment between the cord 16 and the first magnetic tip 20 may be accomplished by any conventional means, such as by a mechanical attachment or an adhesive attachment. The cord 16 is initially provided extending through the insertion tube 12 with the first cord end 16a and the first magnetic tip 20 located at a distal end 12a of the insertion tube 12 to form an insertion member 21, as seen in FIG. 2. The first magnetic member 20 may comprise a disc or similar shape and is formed with an outer diameter that is larger than an inner diameter of the first insertion tube 12. Hence, in an initial insertion configuration, the first magnetic member 20 rests on the outer edge of the distal end 12a of the insertion tube 12, and the cord 16 extends through the insertion tube 12 and out past a proximal end 12b of the insertion tube 12. The first magnetic member 20 may be formed of a stainless steel magnetic material.

The retrieval tube 14 includes a distal end 14a and a proximal end 14b. A second magnetic member 22 is non-detachably affixed to the distal end 14b of the retrieval tube 14 to form a retrieval member 24. The second magnetic member 22 may comprise a permanent magnet having a cylindrical shape inserted partially within the retrieval tube 14. The second magnetic member 22 may be retained place within the retrieval tube 14 solely by friction and/or an adhesive may be used to affix the second magnetic member 22 to the retrieval tube 14.

It should be noted that, although the first magnetic member 20 is described herein as being a stainless steel material, other magnetic materials may be provided, and the first magnetic member 20 may comprise a magnet. Similarly, in the event that the first magnetic member 20 comprises a magnet, the second magnetic member 22 may comprise a magnetic material such as a stainless steel material. Also, both of the magnetic members 20, 22 may comprise magnets.

Referring to FIGS. 7A-7C, in accordance with an aspect of a method of the present invention, the insertion and retrieval members 21, 24 are used to pass the first end 16a of the support cord 16 into one nostril past the posterior nasal septum, and retrieve the first end 16a through the other nostril such that the first and second ends 16a, 16b of the support cord 16 extend from the patient's nostrils exterior to the nose. In particular, the distal end 12a of the insertion member 21 is inserted within a first nostril 64, and the distal end 14a of the retrieval member 24 within a second nostril 66 such that the magnetic members 20, 22 at the distal ends 12a, 14a are magnetically coupled at a point beyond the posterior nasal septum 62. That is, the second magnetic member 22 and attached support cord 16 are attracted across the posterior nasal septum 62 to engagement with the first magnetic member 20. The retrieval member 14 is pulled out of the second nostril 66, drawing the magnetically coupled support cord 16 around the posterior nasal septum 62 such that the ends of the support cord 16 extend external to each nostril 64, 66. Subsequently, a nasal tube 58 is inserted into one of the patient's nostrils 64, 66, and the nasal tube 58 and cord ends 16a, 16b are secured together using the clip member 18, as is described further below.

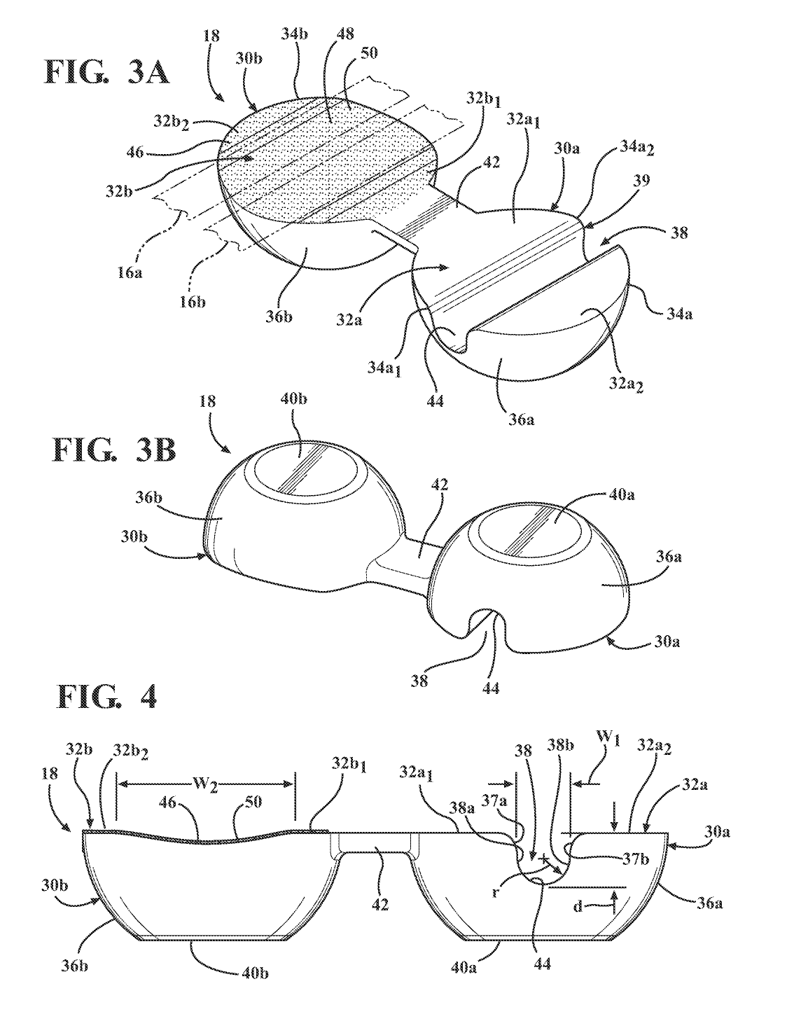

Referring to FIGS. 3A, 3B and 4, the clip member 18 includes first and second pivotally connected clip portions 30a, 30b. Each of the clip portions 30a, 30b include a respective inner mating surface 32a, 32b for mating engagement with the mating surface 32a, 32b of the other clip portion 30a, 30b. The mating surface 32a, 32b of each clip portion 30a, 30b defines a respective generally circular perimeter 34a, 34b at an intersection of the mating surface 32a, 32b with an outer surface 36a, 36b of the clip portion 30a, 30b, wherein the perimeters 34a, 34b define generally similar diameters. Further, the mating surfaces 32a, 32b are at least partially defined by respective planar mating surfaces, wherein the mating surface 32a includes planar mating surfaces 32a₁ and 32a₂, and the mating surface 32b includes planar mating surfaces 32b₁ and 32b₂.

As seen in FIG. 3A, the first clip portion 30a includes an elongated nasal tube channel 38 extending from the mating surface 32a into the first clip portion 30a. In particular, the channel 38 extends below the mating surface 32a, with the planar mating portions 32a₁, 32a₂ extending to either side of the channel 38. The channel 38 extends between diametrically opposite sides 34a₁, 34a₂ of the perimeter 34a to provide a passage for the nasal tube 58 (FIG. 7C) through the clip member 18. Further, the edges 37a, 37b formed between the planar mating portions 34a₁, 34a₂ and channel walls 38a, 38b are formed as chamfered edges forming a channel opening 39 that is wider than the spacing between the channel walls 38a, 38b to facilitate passage of the nasal tube 58 into the channel 38.

Each of the clip portions 30a, 30b are formed with a generally hemispherical shape, as defined by arcuate surfaces of the respective outer surfaces 36a, 36b. When the mating surfaces 32a, 32b are positioned in mating engagement with each other, the outer surfaces of the clip portions 30a, 30b form a generally spherical shape for the outer surface for the clip member 18. More specifically, as may be seen in FIG. 3B, the outer surfaces 36a, 36b preferably comprise frusto-hemispherical surfaces including respective outer flat surfaces 40a, 40b. That is, the arcuate outer surfaces 36a, 36b end in the outer flat surfaces 40a, 40b to form the clip member 18 with a frusto-spherical shape, including opposing frusto-spherical ends (see FIG. 6).

The clip portions 30a, 30b are formed of a soft elastomeric material and, in accordance with an aspect of the invention, the clip portions 30a, 30b are preferably formed of relatively soft silicone material that flexes resiliently in response to a pressure applied to a surface thereof. Alternatively, the clip portions 30a, 30b may be formed of a soft elastomeric material comprising a soft TPE material. In accordance with a specific example of a relatively soft elastomeric material, the clip portions 30a, 30b are formed of elastomeric material in a durometer Shore A range of 40 or less. Further, the clip portions 30a, 30b are pivotally connected by a hinge portion 42. The hinge portion 42 is integrally formed with the clip portions 30a, 30b, such as during a molding operation forming the clip portions 30a, 30b.

Referring to FIG. 4, the channel 38 is dimensioned with a spacing between the channel walls 38a, 38b that is equal to or about equal to a diameter of the nasal tube 58 such the channel walls 38a, 38b engage against the outside of the nasal tube 58 to form a static friction connection, i.e., a stiction connection, therebetween. The nasal tube 58 may be formed, for example, of polyvinyl chloride (PVC) or polyurethane (PUR). The channel 38 includes a radially inner surface 44 defining a radius, r, that is generally equal to one-half an outer diameter of the nasal tube 58. Further, a depth, d, of the channel 38, as measured from the mating surface 32a to an apex of the inner surface 44 of the channel 38 is generally equal to the width, w₁, of the channel 38, as measured between the channel walls 38a, 38b.

It may be understood that the width, w₁, of the channel 38 being about equal to the diameter of the nasal tube 58 may include tolerance variations that may increase engagement of the inner surface 44 with the lower or inner half of the nasal tube 58. However, the soft characteristic of the elastomeric material, producing the stiction engagement with the nasal tube 58, is also sufficient to resist movement due to the contact that necessarily occurs along the length of the channel 38 at the radially inner locations engaging the nasal tube 58, i.e., at locations radially inwardly into the channel 38 away from the opening 39. In addition, it may be understood that the opening 39 of the channel 38 is outwardly curved to provide an unobstructed opening, that the nasal tube 58 may easily slide into position without catching on portions of the side walls 38a, 38b at the opening 39.

As illustrated in FIGS. 3A and 4, at least one of the first and second clip portions 30a, 30b includes an adhesive coating 46 on a respective mating surface 32a, 32b thereof. Alternatively, the adhesive coating 46 may be provided to both of the mating surfaces 32a, 32b. In the illustrated preferred example, the adhesive coating 46 is applied only to the mating surface 32b of the second clip portion 30b. The adhesive coating 46 creates an immovable or permanent bond between the mating surface 32b of the second clip portion 30b and a portion of the nasal tube 58 surface facing outwardly from the channel 38 when the mating surfaces 32a, 32b are in engagement with each other. Further, the adhesive coating 46 permanently bonds at least the planar mating surfaces 32a₁, 32a₂ and 32b₁, 32b₂ to each other when the first and second clip portion 30a, 30b are pivoted about the hinge 42 into engagement with each other.

Prior to pivoting closure of the first and second clip portion 30a, 30b into engagement with each other, the first and second ends 16a, 16b of the support cord 16 may be positioned on either side of the channel 38 after the nasal tube 58 is located therein, as is illustrated in FIG. 7C. When the mating surfaces 32a, 32b are brought into engagement with each other, the cord ends 16a, 16b may be adhesively engaged by the adhesive coating 46 and located between the mating surfaces 32a, 32b, to immovably retain the cord ends 16a, 16b in engagement with the clip member 18. It may be understood that, although the cord ends 16a, 16b cover a portion of the adhesive coating 46, such as may be provided on the mating surface 32b, at least a portion of the planar mating surfaces 32b₁, 32b₂ will remain uncovered by the cord ends 16a, 16b for engagement with the respective planar mating surfaces 32a₁, 32a₂. Also, a central elongated area defined by a longitudinally extending spacing between the cord ends 16a, 16b is preferably provided to permit contact of the adhesive coating 46 with the outer surface of the nasal tube 58.

Further, a central area 48 of the mating surface 32b on the second clip portion 30b may be formed with a shallow elongated indentation 50 for receiving the cord ends 16a, 16b. The elongated indentation has a width, w₂, that is contiguous with and extends laterally outwardly from the width, w₁, of the channel 38 when the clip portions 30a, 30b are in mating engagement. The elongated indentation 50 is formed with a depth substantially matching a thickness of the cord ends 16a, 16b to thereby permit additional closure of the clip portions 30a, 30b together, with sufficient space in the indentation 50 to accommodate the cord ends 16a, 16b, for more complete contact between the planar mating surfaces 32a₁, 32a₂ and 32b₁, 32b₂. It may be understood that, within the scope of the invention, an operable embodiment of the clip member 18 may be formed by providing the entire mating surface 32b of the second clip portion 30b as a planar surface, without the indentation 50.

Prior to engagement of the mating surfaces 32a, 32b to permanently affix the clip member to the nasal tube 58 and the cord ends 16a, 16b, the adhesive coating 46 may be covered with a detachable film cover 52. That is, the clip member 18 may initially be provided with a protective film cover 52 over the adhesive coating 46. The film cover 52 may include a tab portion 54 for enabling a user to conveniently grasp the film cover 52 and peel it from engagement on the mating surface 32b to expose the adhesive coating 46.

In one example of a use of the clip member 18, subsequent to insertion of the nasal tube 58 into a nostril of the patient, the clip member 18 is positioned onto the nasal tube 58 such that the channel 38 receives the nasal tube 58. The clip member 18 remains in a selected position adjacent to the patient's nostril due to the frictional engagement created between the outer surface of the nasal tube 58 and the soft elastomeric material of the channel walls 38a, 38b. The film cover 52 may then be peeled from the second mating surface 32a, and the cord ends 16a, 16b may be positioned on the adhesive layer 46 at least partly spaced to expose a strip of the adhesive 46 therebetween. The first and second clip portions 30a, 30b may be pivoted together to join the mating surfaces 32a, 32b and to engage the exposed strip of adhesive 46 between the cord ends 16a, 16b with the nasal tube 58, as illustrated in FIG. 6.

In order to form a secure bond between the mating surfaces 32a, 32b, the user applies pressure to the opposing frusto-spherical ends at the outer flat ends 40a, 40b to firmly compress the clip portions 30a, 30b together. The outer flat ends 40a, 40b facilitate stable engagement of the user's fingers with the outer surfaces 36a, 36b of the clip member 18. Further, the frusto-spherical shape of the clip member 18 may have a diameter, e.g., as measured across the perimeters 34a, 34b, of about one-half inch and provides a member that will have a minimum contact surface area with a patient's face below the patient's nose 60. Additionally, the frusto-spherical shape, in combination with the soft elastomeric material, operates such that points of engagement between the clip member 18 and the patient's face comprise rounded soft surfaces, permitting a distribution of pressure at points of contact with the patient's face. Hence, the configuration of the present clip member 18 reduces discomfort that may be associated with other clip constructions by implementing a combination of shape and material, as well as reduced size, to minimize or reduce contact pressure on the patient's face. It may be noted that the size of the clip member 18 is such that it is prevented from entering the patient's nostril, while minimizing the diameter.

Further, the configuration of the clip member 18 facilitates installation by providing a channel which easily slips over the nasal tube 58 and remains in position by frictional engagement. The positioning and retention of the cord ends 16a, 16b in the clip member 18, and closure of the clip member 18, are facilitated by the adhesive coating 46 that may be applied to one or both of the mating surfaces 32a, 32b, enabling a secure installation with a minimum of parts or elements forming the clip member 18.

It may be understood that the clip member 18 may be molded having a channel sized to any tube that is to be used with the clip member 18, and that a variety of clip members 18, having various sized channels 38, as well as various size outer diameters, to accommodate the various tube sizes commonly used, may be provided.

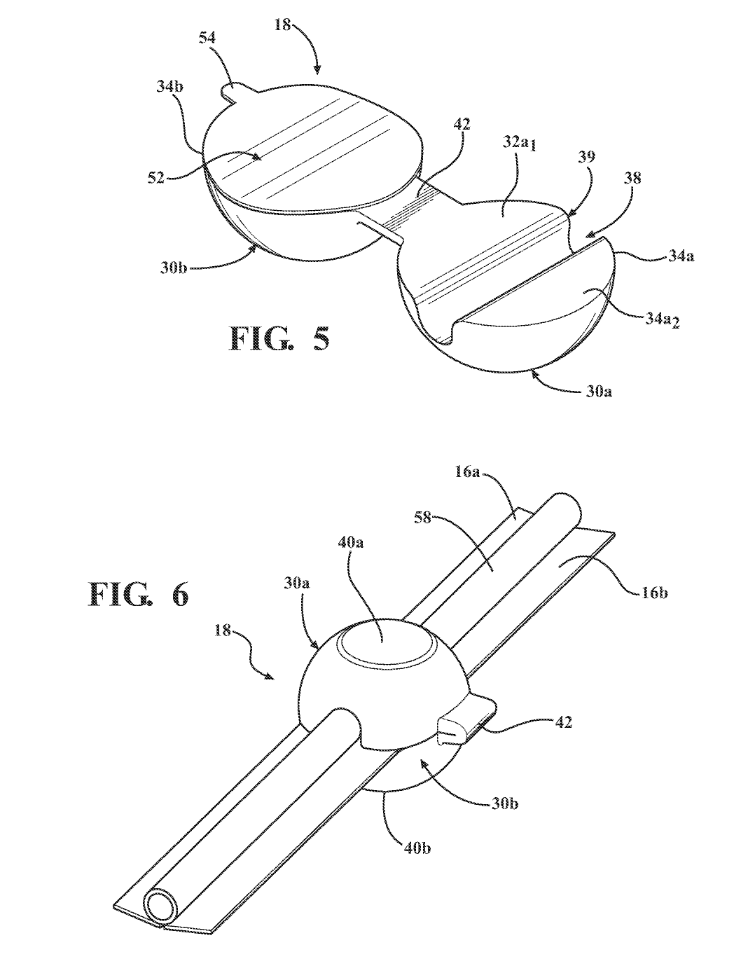

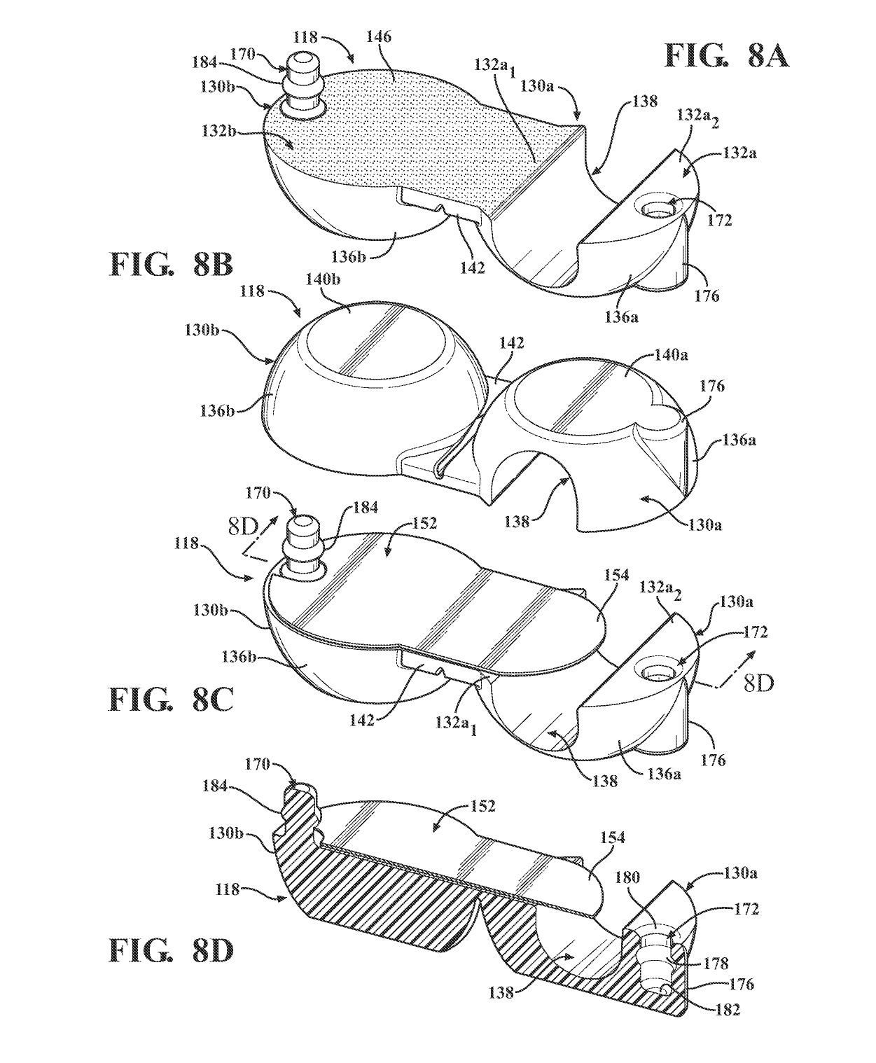

Referring to FIGS. 8A-D, an alternative configuration for the clip member is illustrated. Elements of the clip member 118 of the alternative configuration shown in FIGS. 8A-D and corresponding to the clip member 18 described with reference to FIGS. 3A, 3B, 4 and 5 are labeled with the same reference numerals increased by 100.

The clip member 118 includes first and second pivotally connected clip portions 130a, 130b. Each of the clip portions 130a, 130b include a respective inner mating surface 132a, 132b for mating engagement with the mating surface 132a, 132b of the other clip portion 130a, 130b. The mating surfaces 132a, 132b are at least partially defined by respective planar mating surfaces, wherein the mating surface 132a includes planar mating surfaces 132a₁ and 132a₂, and the entire mating surface 132b comprises a planar mating surface. An elongated nasal tube channel 138 extends into the first clip portion 130a between the planar mating surfaces 132a₁ and 132a₂ for receiving a nasal tube 58 as described above. The clip portions 130a, 130b are pivotally connected by an integrally formed hinge portion 142.

In the current configuration, an adhesive coating 146 is applied to the second mating surface 132 and may extend across the hinge 142 and the planar mating surface 132a₁ to the edge of the channel 138. Further, as illustrated in FIG. 8C, a film cover 152 may be provided to cover the adhesive coating 146, and a tab 154 of the film cover 152 extends beyond the planar mating surface 132a₁ and over the channel 138 to facilitate grasping the film cover 152 for removal during use of the clip member 118.

In accordance with an aspect of the invention, the clip member 118 includes a clasp structure comprising a pin 170 molded on the second clip portion 130b and extending outwardly from the plane of the mating surface 132b, and a pin receiving hole 172 molded in the planar mating surface 132a₂. The outer surface 136a of the first clip portion 130a may include a boss 176 to provide additional material on the first clip portion 130a for accommodating the pin receiving hole 172. The pin receiving hole 172 is located on the first clip portion 130a to receive the pin 170 when the first and second clip portions 130a, 130b are in mating engagement with each other.

As may be seen in FIG. 8D, the pin receiving hole 172 may include a circular groove 178 located between an entrance 180 and a bottom 182 of the hole 172. The groove 178 is configured to engage a rib 184 formed on the circumference of the pin 170 to provide a locking engagement between the pin 170 and hole 172 to prevent or substantially resist separation of the mating surfaces 132a, 132b of the first and second clip portions 130a, 130b. It should be understood that the clasp structure formed by the pin 170 and pin receiving hole 172 is provided in addition to the adhesive coating 146 for maintaining the first and second mating surfaces 132a, 132b in engagement with each other.

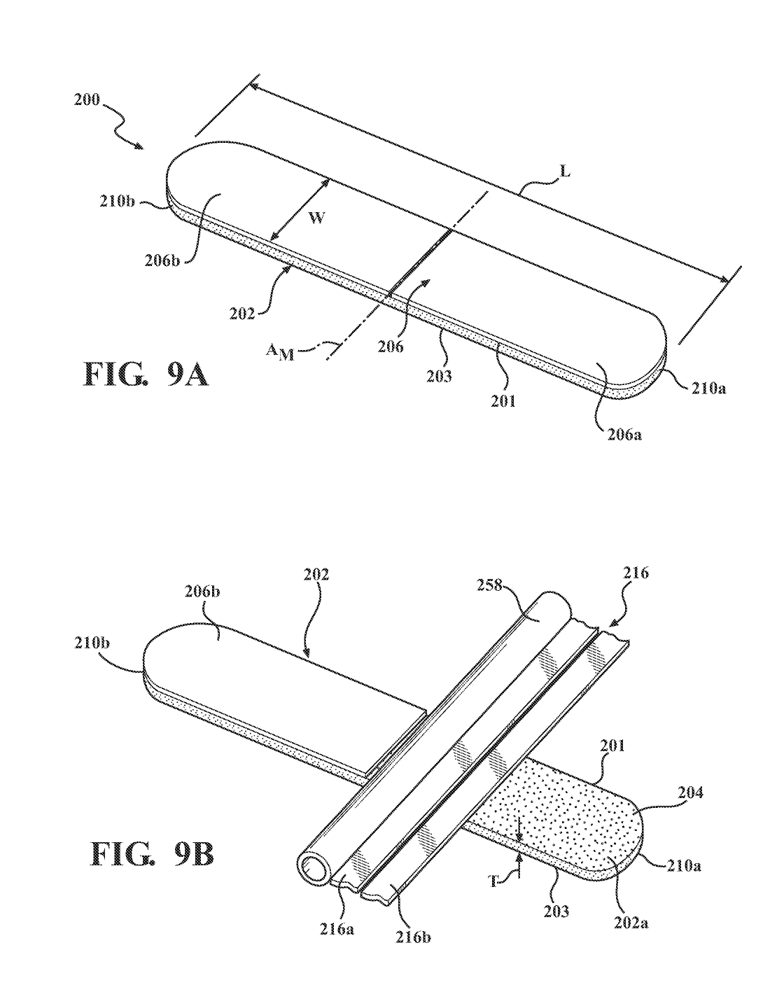

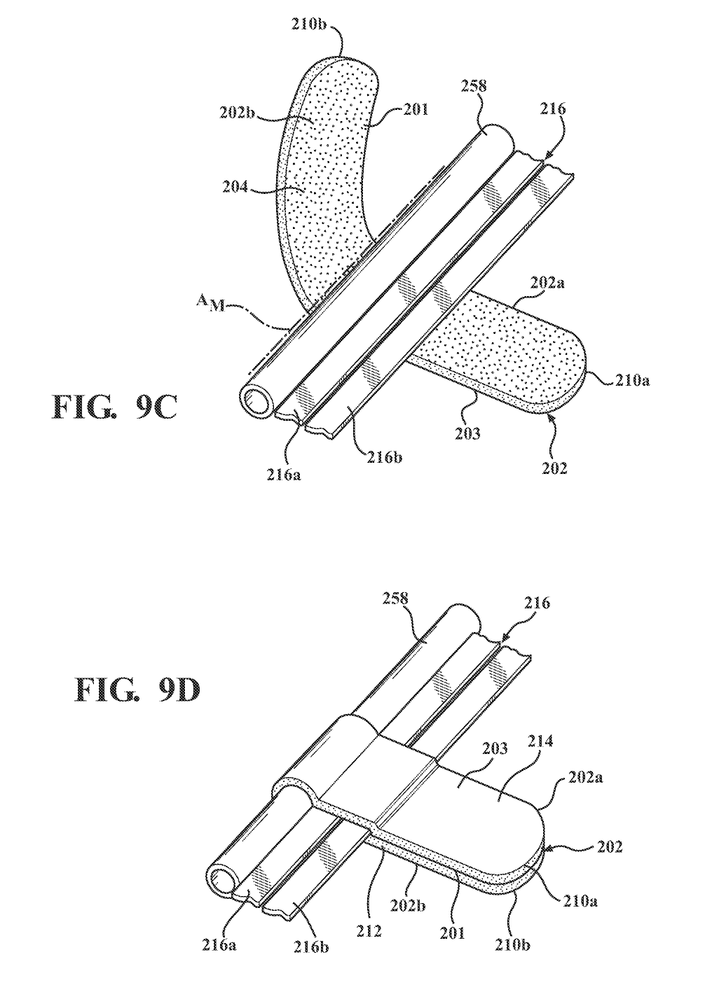

Referring to FIGS. 9A-D, a further alternative configuration for the clip member is illustrated. Generally, the present configuration provides a clip member 200 for use in a nasal retention system for securing at least one nasal tube 258 extending through a nose of a patient. The nasal retention system can further be provided in combination with a support cord 216 extending around a nasal septum of the patient and having opposing ends 216a, 216b, each cord end extending from a nostril of the nose in a manner similar to that described above with reference to the clip member 18. As is described below, the clip member 200 can be engaged with both the nasal tube 258 and the ends 216a, 216b of the support cord 216.

Referring to FIG. 9A, the clip member 200 includes an elongated body 202 formed of a resilient material. Preferably, the resilient material is a closed cell foam material, and may be formed of a medical grade foam. A preferred exemplary medical grade foam can be characterized by a closed-cell foam formed of a polyethylene material that is non-toxic, hypoallergenic and latex free. The elongated body 202 has oppositely facing first and second planar sides 201, 203 defining a minor width dimension, W, of the elongated body 202, and a major length dimension, L, of the elongated body 202 that is perpendicular to the minor width dimension, W. The elongated body 202 defines a thickness, T (FIG. 9B), between the first and second planar sides 201, 203, extending perpendicular to the width dimension, W, and the length dimension, L. It may be noted that the elongated body 202 is a flexible member, and the terminology of “first and second planar sides” refers to the geometric configuration of the sides of the elongated body 202 when the clip member 200 is at rest without an outside force applied to it, as is shown in FIG. 9A.

By way of specific example, the elongated body 202 may be formed with a length dimension, L, that is substantially longer than the width dimension, W, such as four times longer than the width dimension, W. For example, the length dimension, L, may be 40 mm, the width dimension, W, may be 10 mm, and the thickness, T, may be 1.0 mm. Hence, the elongated body 202 is a compliant foam strip material, i.e., not a paper or cloth tape material, that has a foam material edge presenting a compliant thickness. The thickness dimension is selected to provide a resilient cushion-like configuration that is nonabrasive if the edge were to engage and move on a patient's skin, and can be formed having a minimum thickness dimension as thin as about 0.5 mm, the thickness dimension being selected such that it avoids formation of a hard and/or sharp edge around the periphery of the elongated body 202. It may be understood that the described length and width dimensions are exemplary of an operable clip member 200, and the elongated body 202 may be formed with other length and width dimensions that meet the general dimensional and functional characteristics described herein.

The first planar side 202a of the elongated body 202 includes an adhesive coating 204, such as a medically compatible adhesive. That is, an adhesive that is demonstrated to be safe (non-irritating) if it contacts skin and that maintains its tackiness if contacted with fluids in the environment of the nasal tube adjacent to a patient's nose. A detachable film cover 206 is applied, i.e., removably attached, over the adhesive coating 204. The film cover 206 can be formed of paper strip material, and can be formed as a first elongated film cover portion 206a and a second elongated film cover portion 206. In particular, the first film cover portion 206a can be located on a first portion 202a of the first planar side 201 of the elongated body 202, and the second film cover 206b can be located on a second portion 202b of the first planar side 201 of the elongated body 202. The first and second portions 202a, 202b are located on longitudinally opposing sides of a minor axis A_{M} that is parallel to the minor width dimension, W, located about midway between first and second ends 210a, 210b of the elongated body 202. That is, the first film cover portion 206a is positioned over the adhesive coating 204 and extends over the first portion 202a of the first planar side 201 from the first end 210a to a center of the elongated body 202, at or adjacent to the minor axis A_{M}; and the second film cover portion 206b is positioned over the adhesive coating 204 and extends over the second portion 202b of the first planar side 201 from the second end 210b to the center of the elongated body 202 where an edge of the second film cover portion 206b is adjacent to an edge of the first film cover portion 206a.

In accordance with a method of using the nasal retention system including the clip member 200, the support cord 216 can be inserted through a patient's nostrils, along with the nasal tube 258, as has been previously described above. The clip member 200 is configured to secure the nasal tube 258 by initially removing the film cover 206 to expose the adhesive coating 204. Specifically, as an initial step, the first film cover portion 206a can be removed to expose the adhesive on the first portion 202a of the elongated body 202 from the first end 210a to the minor axis A_{M}.

The clip member 200 is then positioned adjacent to the patient's nose with the nasal tube 258 located extending perpendicular to the major length dimension, L, and the ends 216a, 216b of the support cord 216 are located adjacent to the nasal tube 258 adhered on the first portion 202a of the elongated body 202, as is illustrated in FIG. 9B. Hence, removal of the first film cover portion 206a can define an initial placement or reference location of the nasal tube 258 and support cord 216 on the elongated body 202 adjacent to the edge of the second film cover portion 206b at the minor axis A_{M}. Additionally, a length of the second film cover portion 206b may be different from a length of the first film cover portion 206a to change the reference location, such as to define a longer second film cover portion 206b to bend around the nasal tube 258 during formation of a clamping configuration, as is described further below.

Subsequently, the second film cover portion 206b can be removed from the clip member 200, and the length of the elongated body 202 defining the second portion 202b can be pivoted or bent about the minor axis A_{M} parallel to the minor dimension, W, (FIG. 9C) to overlap over the nasal tube 258 and support cord 216 on the length of the elongated body 202 defining the first portion 202a. The first portion 202a of the first planar side 201 is adhered to the second portion 202b of the first planar side 201 to thereby secure the nasal tube 258 and the first and second ends 216a, 216b of the support cord 216 in fixed relation between the first and second portions 202a, 202b of the first planar side 201 and define a nasal tube clamping configuration for the clip member 200, as seen in FIG. 9D.

In the clamping configuration illustrated in FIG. 9D, all of the exterior surfaces of the clip member 200 are entirely defined by surfaces of the closed cell foam material. That is, the exterior surfaces of the clip member 200, as defined by the second side 203 and peripheral edges 212 of the elongated body 202, are defined entirely by the closed cell foam material forming the elongated body 202, such that the exposed surfaces of the clip member 200 present a soft material for contact with the patient. Also, the resilient/compliant nature of the foam material enables the entire clamping configuration to have a low rigidity that permits a controlled flexing movement of the nasal tube 248 and support cord ends 210a, 210b relative to each other within the assembly, including limited resilient movement in the direction of the major length dimension, which is believed to contribute to the comfort of the patient.

Further, it may be noted that the first and second ends 210a, 210b of the elongated body 202 can be defined as curved edges that avoid sharp contact locations for engagement with the patient. The joined first and second portions 202a, 202b of the first side 201 define a tail portion 214 of the clip member 200 that extends laterally out from the location of the nasal tube 258 and support cord 216. At least a portion of this tail portion 214 between the ends 210a, 210b and the nasal tube 258 and support cord 216 can be trimmed or shortened to reduce the surface area available for contact with the patient, and the trimmed edge may be formed with a curvature similar to that illustrated for ends 210a, 210b. Additionally, it should be understood that although a particular arrangement of the nasal tube 258 and the support cord 216 is illustrated in relation to the clip member 200, other arrangements may be provided such as, for example, placing one or both of the support cord ends 216a, 216b adjacent to the bend defined at the minor axis A_{M}.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A nasal retention system for securing at least one nasal tube extending through a nose of a patient, the nasal retention system provided in combination with a nasal tube extending into a nostril of the nose, a support cord extending around a nasal septum of the patient and having opposing ends, each cord end extending from a nostril of the nose, and a clip member engaged with the tube and engaged with the ends of the support cord, the clip member including:
an elongated body formed of a resilient material, the elongated body having oppositely facing first and second planar sides defining a minor width dimension of the elongated body and a major length dimension of the elongated body that is perpendicular to the minor width dimension;
the elongated body defining a thickness between the first and second planar sides;
an adhesive coating on the first planar side, and a detachable film cover applied over the adhesive coating; and
the elongated body is bendable about a minor axis parallel to the minor dimension to adhere a first portion of the first planar side to a second portion of the first planar side.

2. The nasal retention system of claim 1, wherein the film cover is formed by first and second elongated film cover portions, wherein:
a) the first film cover portion extends over the first portion of the first planar side from a first end of the elongated body to a center of the elongated body where an end of the first film cover portion is positioned over the adhesive coating; and
b) the second film cover portion extends over the second portion of the first planar side from a second end of the elongated body to the center of the elongated body.

3. The nasal retention system of claim 2, wherein the first and second ends are defined as curved edges.

4. The nasal retention system of claim 2, wherein the center of the elongated body is defined by a minor axis extending perpendicular to the major dimension and located midway between the first and second ends of the elongated body.

5. The nasal retention system of claim 1, wherein the resilient material is a closed cell foam material.

6. The nasal retention system of claim 5, wherein the elongated body defines a nasal tube clamping configuration when the elongated body is bent about the minor axis, and exterior surfaces of the clamping configuration are entirely defined by surfaces of the closed cell foam material.

7. The nasal retention system of claim 5, wherein the closed cell foam material is compressible in the direction of the thickness of the elongated body.

8. The nasal retention system of claim 7, wherein the closed cell foam material has a thickness of at least 1.0 mm.

9. A method for securing a nasal tube extending through a nose of a patient, the method including providing a retention system comprising a clip member having an elongated body formed of a closed cell foam material having oppositely facing first and second planar sides defining a minor width dimension of the elongated body and a major length dimension of the elongated body that is perpendicular to the minor width dimension; the elongated body defining a thickness between the first and second planar sides; an adhesive coating on the first planar side; a detachable film cover applied over the adhesive coating on the first planar side, the method further including:
passing a first end of a support cord having first and second ends into one nostril past the posterior nasal septum, and retrieving the first end through the other nostril such that the first and second ends of the support cord extend from the patient's nostrils exterior to the nose;
removing the film cover to expose the adhesive coating;
positioning the clip member adjacent to the nose with the nasal tube located extending perpendicular to the major dimension; and
bending the elongated body about a minor axis parallel to the minor dimension to adhere a first portion of the first planar side to a second portion of the first planar side and secure the nasal tube and the first and second ends of the support cord in fixed relation between the first and second portions of the first planar side.

10. The method of claim 9, wherein the film cover is formed by first and second elongated film cover portions, wherein:
a) the first film cover portion extends over the first portion of the first planar side from a first end of the elongated body to a center of the elongated body where an end of the first film cover portion is positioned over the adhesive coating; and
b) the second film cover portion extends over the second portion of the first planar side from a second end of the elongated body to the center of the elongated body.

11. The method of claim 10, wherein removing the film cover is performed by the sequence of steps of:
i) removing the first film cover portion from the first portion of the first planar side;
ii) placing the nasal tube and the first and second ends of the support cord on the first portion of the first planar side; and
iii) removing the second film cover portion from the second portion of the first planar side prior to bending the elongated body about the minor axis to adhere the first and second portions of the first planar side to each other.

12. The method of claim 11, wherein adhering the first and second portions of the first planar side to each other includes placing the first and second ends of the elongated body adjacent to each other, and a tail end of the clip is formed comprising a portion of the elongated body extending from the first and second ends to a location on one of the nasal tube and the first and second ends of the support cord.

13. The method of claim 12, including trimming a portion of the tail end.

14. The method of claim 9, wherein the elongated body defines a nasal tube clamping configuration when the elongated body is bent about the minor axis, and exterior surfaces of the clamping configuration are entirely defined by surfaces of the closed cell foam material.

15. The nasal retention system of claim 9, wherein the closed cell foam material is compressible in the direction of the thickness of the elongated body.

16. The nasal retention system of claim 15, wherein the closed cell foam material has a thickness of at least 1.0 mm.
